(19) United States
(12) Patent Application Publication
(10) Pub. No.: US 2013/0056015 A1
(43) Pub. Date: Mar. 7, 2013

(54) DEAD SKIN REMOVING DEVICE FOR A HUMAN FOOT, AND METHOD FOR FORMING THE SAME

(71) Applicant: Wei-Jen Wang, Taichung City (TW)

(72) Inventor: Wei-Jen Wang, Taichung City (TW)

(21) Appl. No.: 13/597,320

(22) Filed: Aug. 29, 2012

(30) Foreign Application Priority Data
Sep. 6, 2011 (TW) 100216650

(51) Int. Cl. A45D 29/18; B23P 17/00

(52) U.S. Cl. 132/76.4; 29/527.1

(57) ABSTRACT

A dead skin removing device for a human foot includes a liquid plastic sock, a patch member, and a reinforcing pad. The liquidproof plastic sock defines an inner space and an opening to permit insertion of the human foot into the inner space therethrough, and is formed by plastic-welding a liquidproof plastic sheet. The patch member is disposed in the inner space and bonded to the liquid plastic sheet. The reinforcing pad is disposed on the patch member in the inner space to be registered with a heel or metatarsal region of the liquidproof plastic sheet, such that the human foot inserted into the inner space comes into contact with the patch member and has a heel or metatarsal part in intimate contact with the reinforcing pad.

### CROSS-REFERENCE TO RELATED APPLICATION

This application claims priority of Taiwanese application no. 100216650, filed on Sep. 6, 2011.

### BACKGROUND OF THE INVENTION

1. Field of the Invention

This invention relates to a dead skin removing device, more particularly to a dead skin removing device for a human foot, and a method for forming the same.

2. Description of the Related Art

FIGS. 1 to 3 show a conventional dead skin removing device 11 for a human foot, which is used to remove excess layers of dead skin cells from the surface of foot skin to give the foot skin a younger look. The dead skin removing device 11 includes two plastic pieces 111 and two patch pieces 112. The two plastic pieces 111 are matingly welded to each other to define an inner space 115 therebetween, and respectively have unwelded upper edges that cooperate to define an opening 110 communicated with the inner space 115 so as to permit insertion of the foot into the inner space 115 through the opening 110. The two patch pieces 112, each soaked with a well-known exfoliating agent 113, are disposed in the inner space 115 and are respectively bonded to the two plastic pieces 111.

Although the exfoliating agent 113 retained in the patch pieces 112 can be used to remove dead skin on the foot, dead skin on a heel part 191 and a metatarsal part 192 of the human foot may not be effectively removed since the heel part 191 and the metatarsal part 192 are likely to have thicker layers of dead skin cells.

### SUMMARY OF THE INVENTION

Therefore, an object of this invention is to provide a dead skin removing device for a human foot.

Another object of this invention is to provide a method of forming a dead skin removing device for a human foot. Dead skin on the heel and the metatarsal parts of the human foot can be removed effectively by virtue of the dead skin removing device.

According to the first aspect of this invention, a dead skin removing device for a human foot includes a liquidproof plastic sock, a patch member, and a reinforcing pad. The liquidproof plastic sock defines an inner space for receiving the human foot, and is formed by plastic-welding a liquidproof plastic sheet which includes left and right segments, and a middle segment that is flanked by the left and right segments in a first direction. The middle segment has first and second marginal regions disposed oppositely in a second direction that is transverse to the first direction, and heel and metatarsal regions disposed between the first and second marginal regions. The first marginal region has a first gusset-shape cutout zone extending in the second direction toward the second marginal region to define first and second toe-side edges that converge to terminate at a first apical area, and that are plastic-welded to each other. The second marginal region has a second gusset-shape cutout zone extending in the second direction toward the first marginal region to define first and second heel-side edges that converge to terminate at a second apical area, and that are plastic-welded to each other. The left segment has a first left marginal edge, a second left marginal edge, and a first opening-defining marginal edge. The right segment has a first right marginal edge plastic-welded to the first left marginal edge, a second right marginal edge plastic-welded to the second left marginal edge, and a second opening-defining marginal edge disposed opposite to the first opening-defining marginal edge in the first direction, such that the inner space is defined by the left, middle and right segments, and such that the first and second opening-defining marginal edges that are left unwelded cooperatively define an opening to permit insertion of the human foot into the inner space therethrough. The patch member is disposed in the inner space to be bonded to the left, middle and right segments, and is soaked with an exfoliating agent. The reinforcing pad is soaked with the exfoliating agent, and is disposed on the patch member to be registered with one of the heel and metatarsal regions of the middle segment such that the human foot inserted into the inner space comes into contact with the patch member and has a heel or metatarsal part thereof in intimate contact with the reinforcing pad.

According to the second aspect of this invention, a method of forming a dead skin removing device for a human foot includes the steps of: (a) providing a liquidproof plastic sheet that includes left and right segments, and a middle segment which is flanked by the left and right segments in a first direction, and which includes first and second marginal regions disposed oppositely in a second direction that is transverse to the first direction, and heel and metatarsal regions disposed between the first and second marginal regions, the first marginal region having a first gusset-shape cutout zone extending in the second direction toward the second marginal region to define first and second toe-side edges that converge to terminate at a first apical area, the second marginal region having a second gusset-shape cutout zone extending in the second direction toward the first marginal region to define first and second heel-side edges that converge to terminate at a second apical area, the left segment having a first left marginal edge, a second left marginal edge, and a first opening-defining marginal edge, the right segment having a first right marginal edge that is spaced apart from the first left marginal edge by the first marginal region, a second right marginal edge that is spaced apart from the second left marginal edge by the second marginal region, and a second opening-defining marginal edge that is disposed opposite to the first opening-defining marginal edge in the first direction; (b) providing a patch member which has substantially a same configuration as that of the liquidproof plastic sheet and which is superimposed thereupon for bonding therewith; (c) causing a reinforcing pad to be provided on the patch member to be registered with one of the heel and metatarsal regions of the middle segment; (d) causing the patch member and the reinforcing pad to be soaked with an exfoliating agent; and (e) plastic-welding the first left marginal edge to the first right marginal edge, the first toe-side edge to the second toe-side edge, the second left marginal edge to the second right marginal edge, and the first heel-side edge to the second heel-side, such that the liquid plastic sheet is formed into a liquidproof plastic sock having an opening defined by the first and second opening-defining marginal edges that are left unwelded, and an inner space defined by the left, middle and right segments, with the patch member and the reinforcing pad disposed inside the inner space, thereby permitting insertion of the human foot into the inner space through the opening to come into contact with the patch member, with a heel or metatarsal part of the human foot in intimate contact with the reinforcing pad.

### BRIEF DESCRIPTION OF THE DRAWINGS

Other features and advantages of this invention will become apparent in the following detailed description of the preferred embodiments of the invention, with reference to the accompanying drawings, in which:

FIG. 1 is an exploded elevation view of a conventional dead skin removing device;

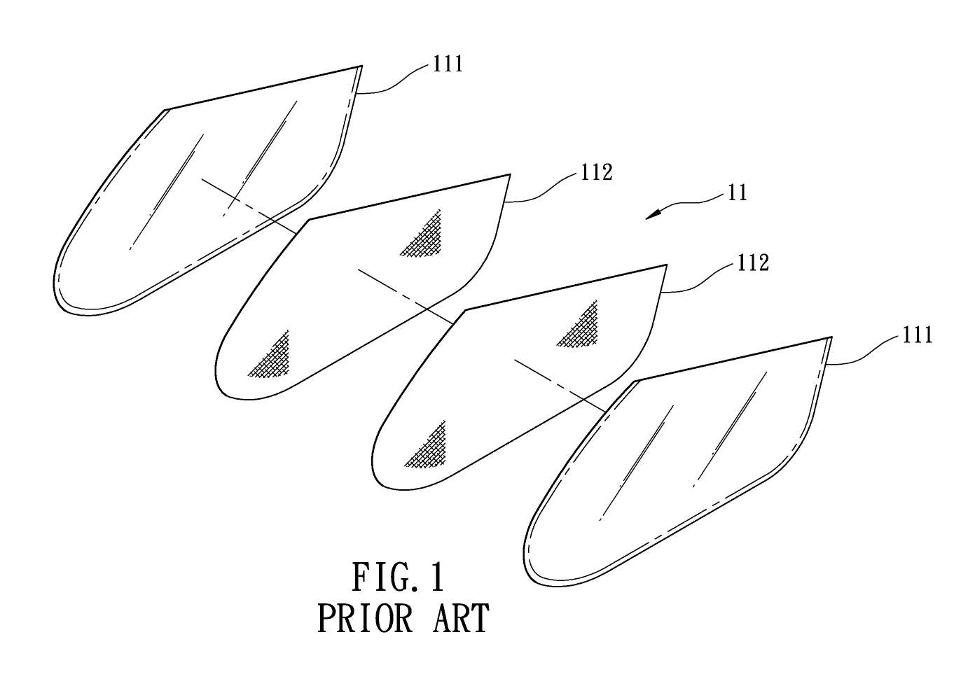

FIG. 2 is a perspective view of the conventional dead skin removing device shown in FIG. 1;

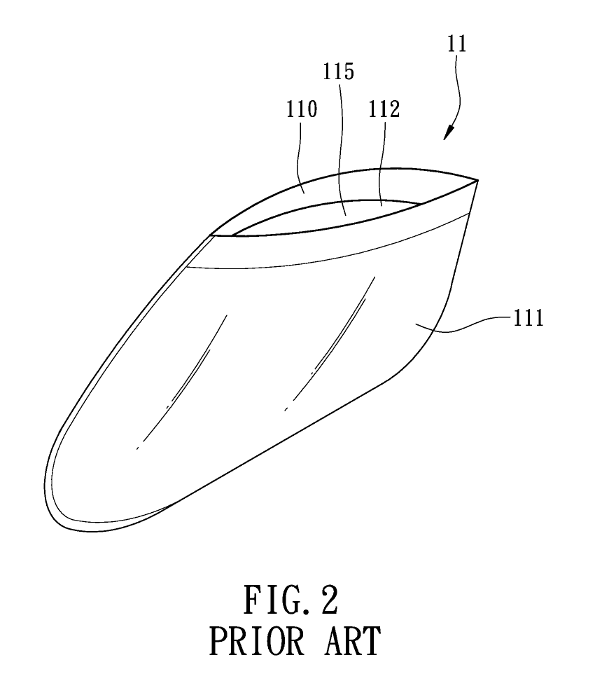

FIG. 3 is a sectional view of FIG. 2, illustrating that a human foot is inserted into the conventional dead skin removing device;

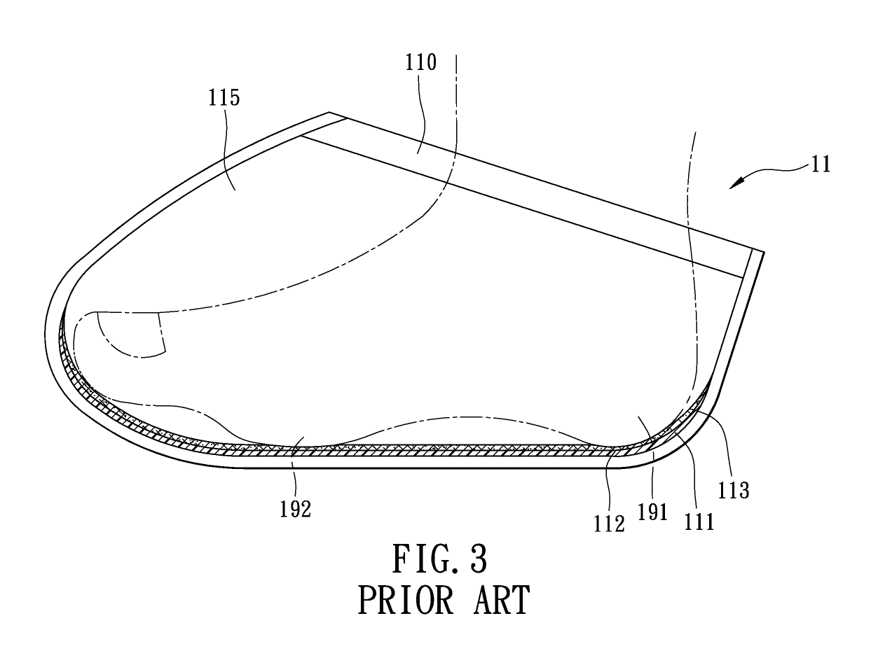

FIG. 4 is an exploded elevation view of a first embodiment of a dead skin removing device for a human foot according to this invention;

FIG. 5 is a perspective view of the dead skin removing device shown in FIG. 4;

FIG. 6 is a sectional view of FIG. 5, illustrating that a human foot is inserted into the dead skin removing device;

FIG. 7 is a sectional view of FIG. 5 taken from another view;

FIG. 8 is a sectional view of a modified version of the first embodiment of a dead skin removing device according to this invention;

FIG. 9 is an exploded elevation view of the second embodiment of a dead skin removing device for a human foot according to this invention;

FIG. 10 is a schematic side view of the dead skin removing device shown in FIG. 9;

FIG. 11 is an exploded elevation view of a third embodiment of a dead skin removing device for a human foot according to this invention, in which a patch member is not yet formed with reinforcing pads;

FIG. 12 is similar to FIG. 11, but showing the patch member formed with pleated reinforcing pads; and

FIG. 13 is a sectional view of the third embodiment of the dead skin removing device according to this invention.

### DETAILED DESCRIPTION OF THE PREFERRED EMBODIMENTS

Before this invention is described in greater detail, it should be noted herein that like elements are denoted by the same reference numerals throughout the disclosure.

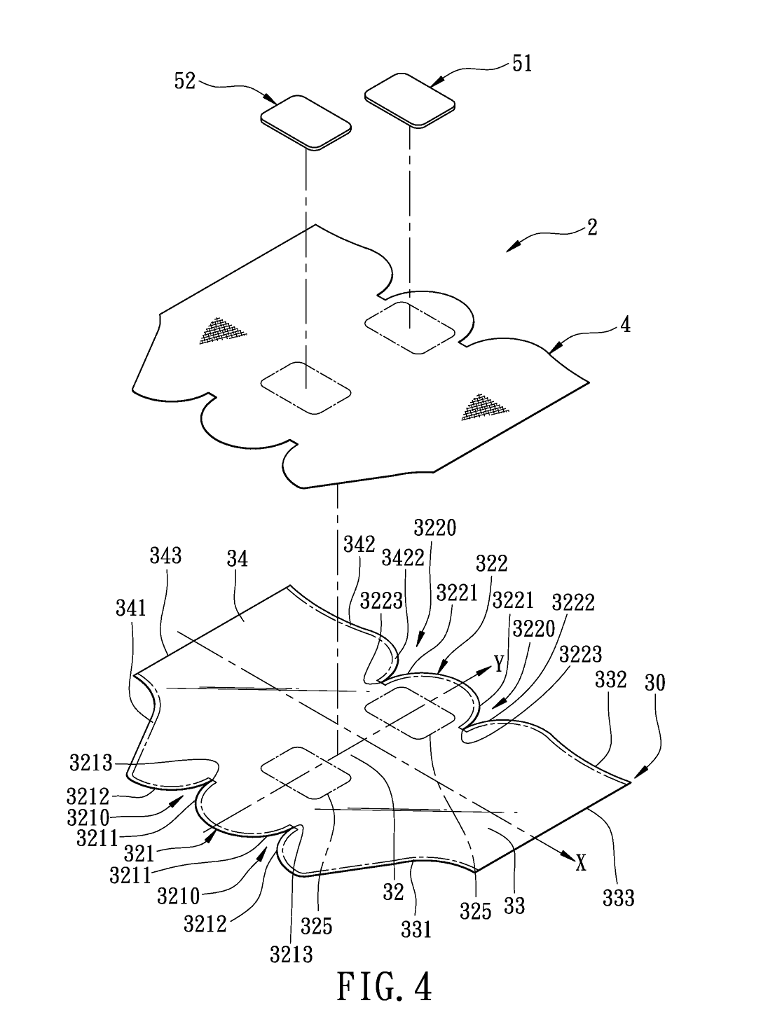

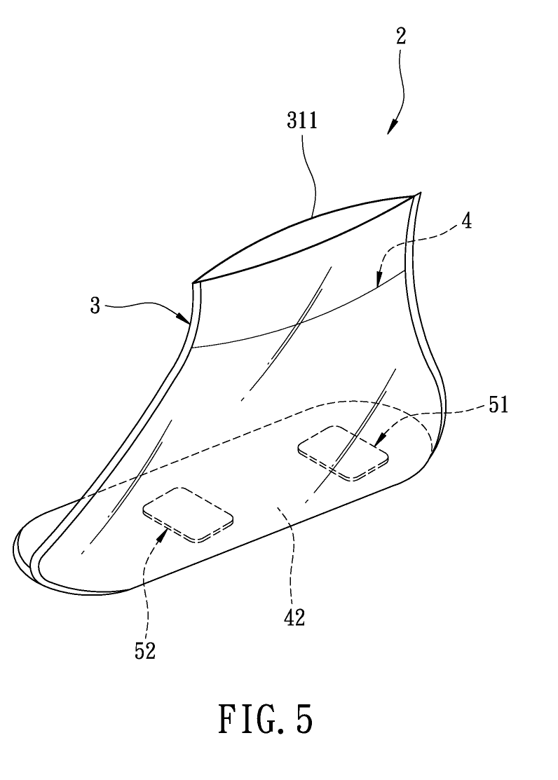

Referring to FIGS. 4 to 7, the first embodiment of a dead skin removing device 2 for a human foot 100 according to this invention includes a liquidproof plastic sock 3 which defines an inner space 300 for receiving the human foot 100, a patch member 4, and first and second reinforcing pads 51, 52.

A method for forming the dead skin removing device 2 includes the following steps (a) to (f).

In step (a), a liquidproof plastic sheet 30 for forming the liquidproof plastic sock 3 is provided (see particularly FIG. 4) , which is made of a liquidproof and airproof plastic material, such as materials commonly used for forming a plastic sock or a plastic glove.

As best shown in FIG. 4, the liquidproof plastic sheet 30 includes left and right segments 33, 34, and a middle segment 32 flanked by the left and right segments 33, 34 in a first direction (X).

The middle segment 32 includes first and second marginal regions 321, 322, and heel and metatarsal regions 325, 326. The first and second marginal regions 321, 322 are disposed oppositely in a second direction (Y) that is transverse to the first direction (X). The heel and metatarsal regions 325, 326 are disposed between the first and second marginal regions 321, 322. The first marginal region 321 has a pair of first gusset-shape cutout zones 3210 each extending in the second direction (Y) toward the second marginal region 322 to define first and second toe-side edges 3211, 3212 that converge to terminate at a first apical area 3213. The second marginal region 322 has a pair of second gusset-shape cutout zones 3220 each extending in the second direction (Y) toward the first marginal region 321 to define first and second heel-side edges 3221, 3222 that converge to terminate at a second apical area 3223.

The left segment 33 has a first left marginal edge 331, a second left marginal edge 332, and a first opening-defining marginal edge 333.

The right segment 34 has a first right marginal edge 341 that is spaced apart from the first left marginal edge 331 by the first marginal region 321, a second right marginal edge 342 that is spaced apart from the second left marginal edge 332 by the second marginal region 322, and a second opening-defining marginal edge 343 that is disposed opposite to the first opening-defining marginal edge 333 in the first direction (X).

In step (b), the patch member 4 is provided, which has substantially a same configuration as that of the liquidproof plastic sheet 30 and which is superimposed thereupon for bonding therewith. The patch member 4 is made of a liquid-absorbable material. In this embodiment, the patch member 4 is made of nonwoven fabric.

In step (c) , the patch member 4 is adhesively bonded to the left, middle, and right segments 33, 32, 34.

In step (d), the reinforcing pads 51, 52 are disposed on the patch member 4 to be registered with the heel region 325 and the metatarsal region 326, respectively. The reinforcing pads 51, 52 are also made of a liquid-absorbable material. In this embodiment, the reinforcing pads 51, 52 are made of nonwoven fabric.

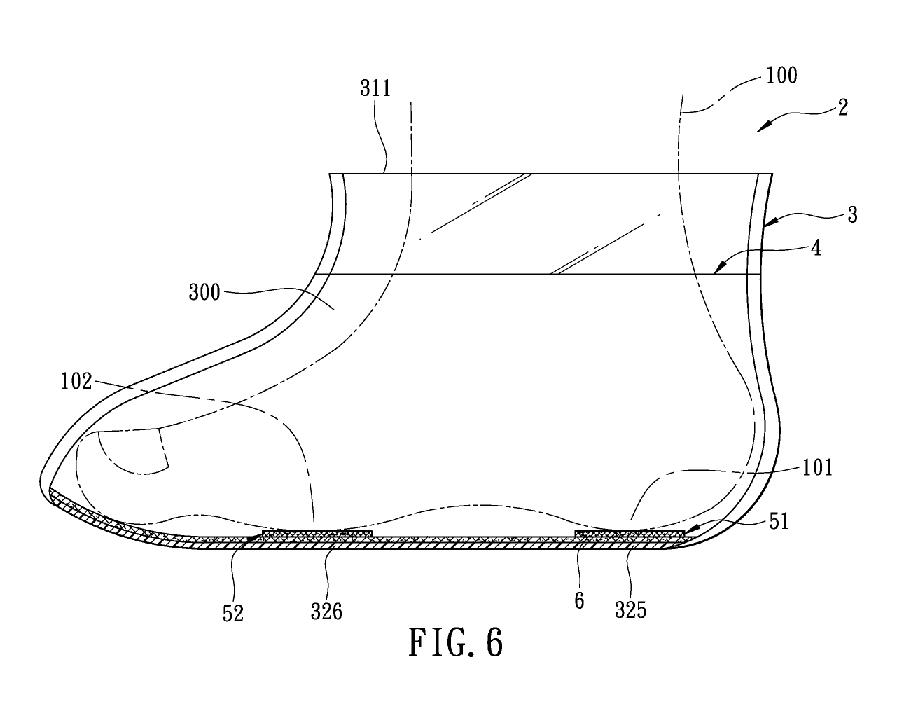

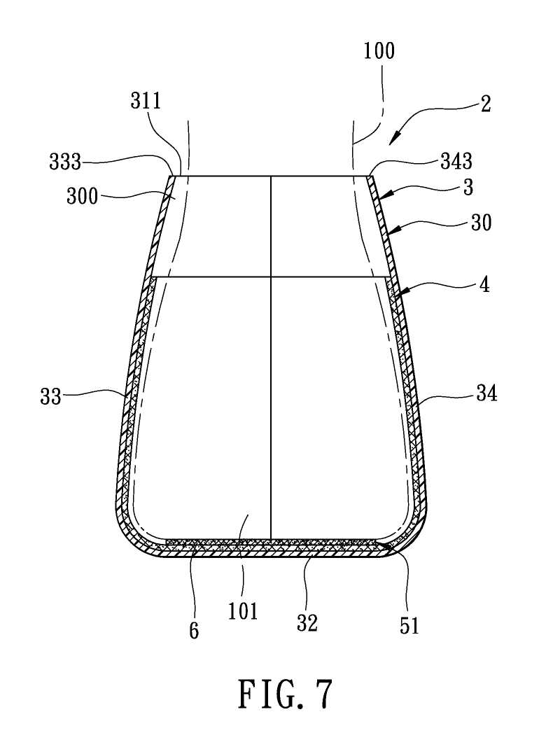

In step (e) , as shown in FIGS. 6 and 7, the patch member 4 and the reinforcing pads 51, 52 are soaked with an exfoliating agent 6 that is well-known in the art.

Step (f) is implemented by plastic-welding (such as heat-sealing or ultrasonic sealing) the first left marginal edge 331 to the first right marginal edge 341, the first toe-side edge 3211 to the second toe-side edge 3212 of each of the first gusset-shape cutout zones 3210, the second left marginal edge 332 to the second right marginal edge 342, the first heel-side edge 3221 to the second heel-side edge 3222 of each of the second gusset-shape cutout zones 322. Thus, the liquidproof plastic sheet 30 is formed into the liquidproof plastic sock 3 that has the inner space 300 defined by the left, middle and right segments 33, 32, 34, and an opening 311 defined by the first and second opening-defining marginal edges 3330, 3430 that are left unwelded. When the human foot 100 is inserted into the inner space 300 through the opening 311, it comes into contact with the patch member 4 and has heel and metatarsal parts 101, 102 thereof in intimate contact with the reinforcing pads 51, 52, respectively.

In this embodiment, the reinforcing pads 51, 52 are adhesively bonded to the patch member 4 using adhesive. In other embodiments, the reinforcing pads 51, 52 may be attached to the patch member 4 by virtue of physical adhesion between the patch member 4 and each of the reinforcing pads 51, 52, or may be detachably attached to the patch member 4 by means of adhesive tapes or Velcro fasteners (not shown). In this case, the reinforcing pads 51, 52 can be disposed based on the positions of the heel part 101 and the metatarsal part 102 of the human foot 100.

In this embodiment, the liquidproof plastic sheet 3 is melt-bonded to the patch member 4 using an ultrasonic device or a heat-sealing device. Alternatively, the patch member 4 may be bonded to the liquidproof plastic sheet 3 by adhesive.

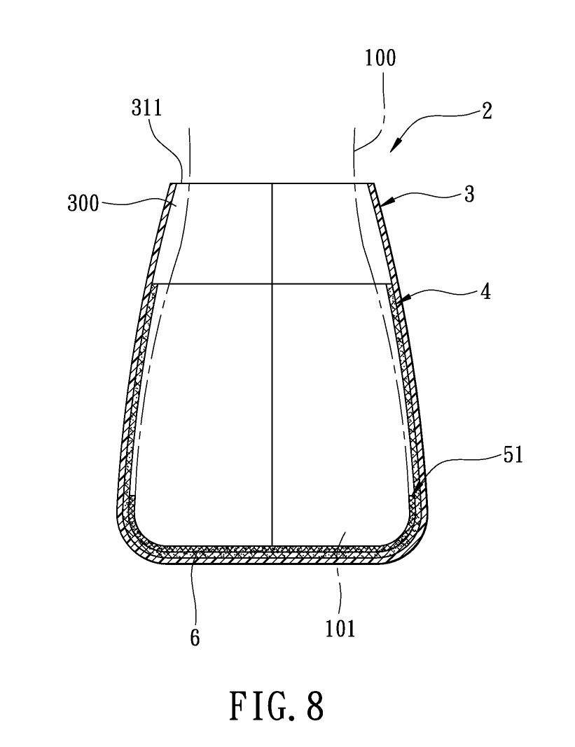

In a modified embodiment, as shown in FIG. 8, each of the reinforcing pads 51, 52 has a width larger than a width of the heel part 101 or the metatarsal part 102 (not shown in FIG. 8) of the human foot 100.

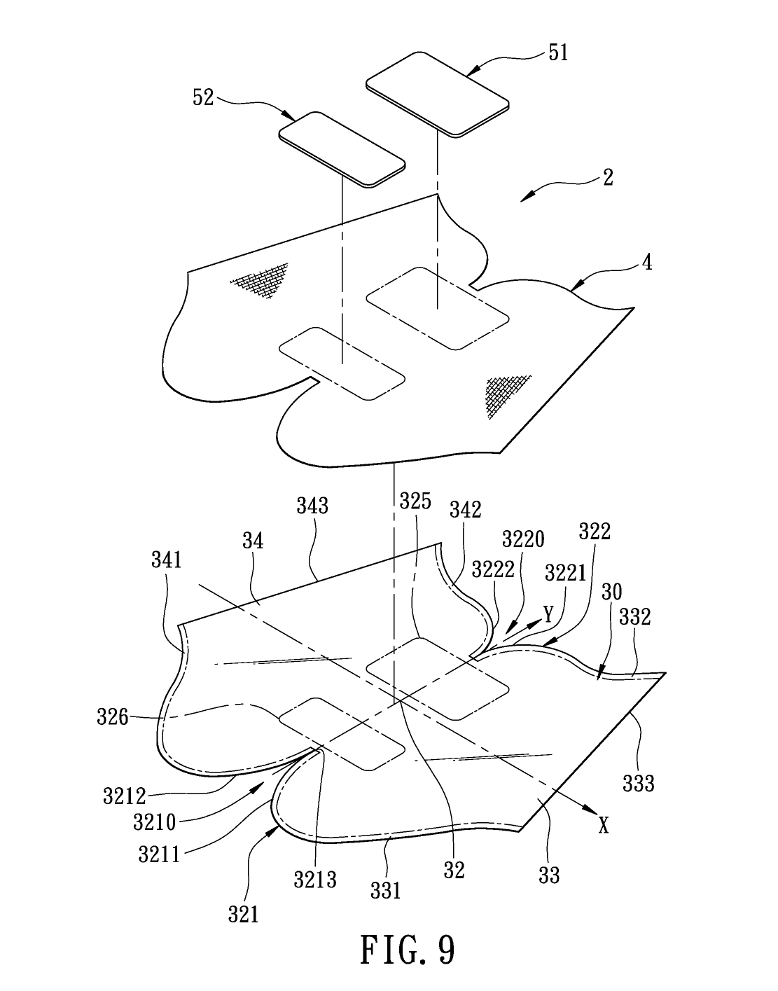

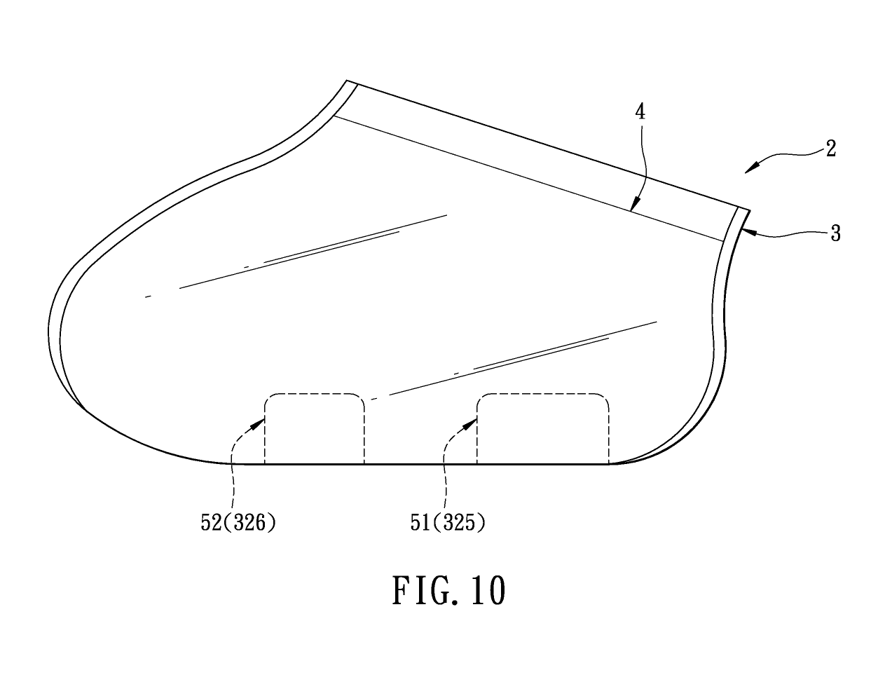

FIGS. 9 and 10 illustrate the second embodiment of a dead skin removing device 2 for a human foot according to this invention. A method for forming the dead skin removing device 2 of the second embodiment differs from that of the first embodiment in that, in step (a), the middle segment 32 has a single first gusset-shape cutout zone 3210 and a single second gusset-shape cutout zone 3220.

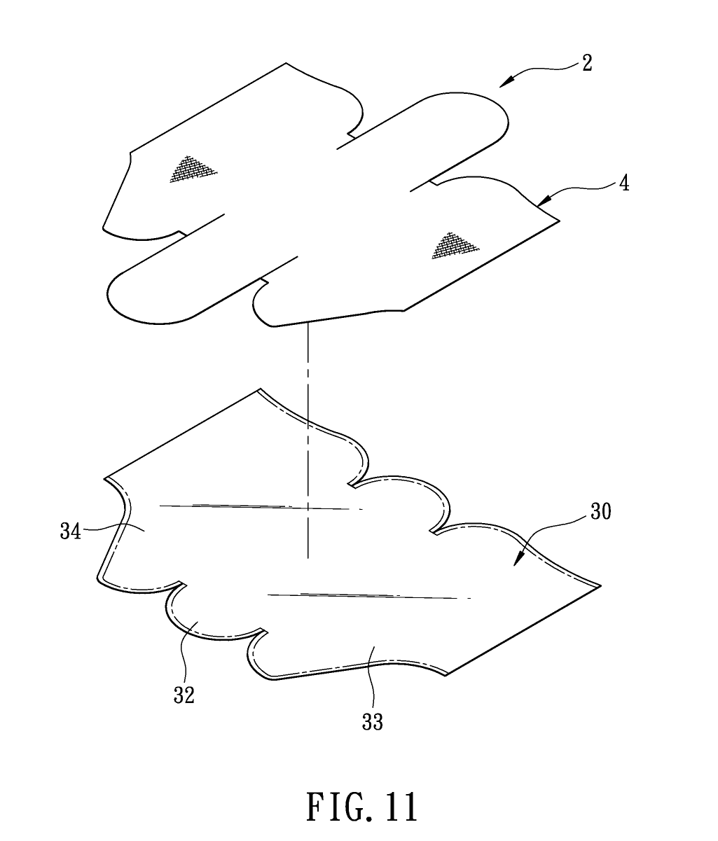

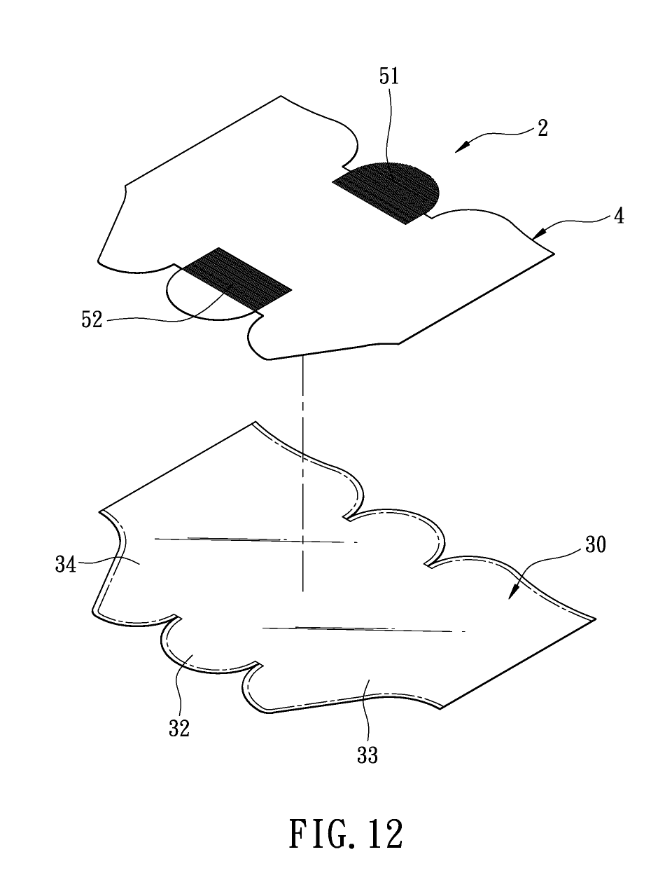

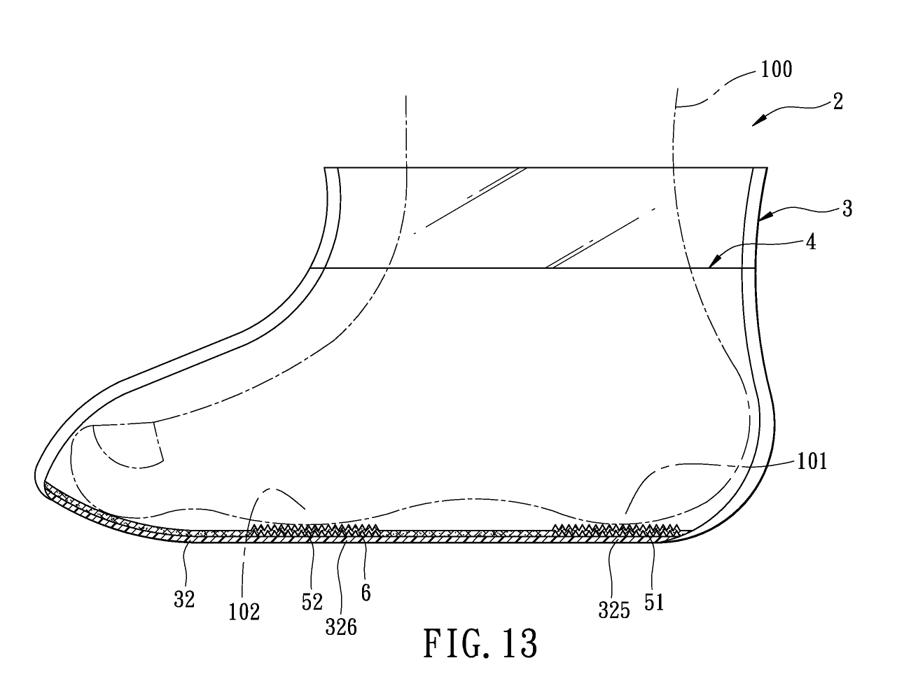

FIGS. 11 to 13 illustrate the third embodiment of a dead skin removing device 2 for a human foot according to this invention. The third embodiment differs from the first embodiment in that each of the reinforcing pads 51, 52 is formed in one-piece with the patch member 4, and is in a pleated form. Alternatively, the reinforcing pads 51, 52 may be pleated by embossing.

Since the reinforcing pads 51, 52 are disposed to be registered with the heel region 325 and the metatarsal region 326, the heel part 101 and the metatarsal part 102 of the human foot 100 can come into intimate contact with the reinforcing pads 51, 52, respectively, thereby permitting effective/efficient removal of dead skin from the heel part 101 and the metatarsal part 102.

While this invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A dead skin removing device for a human foot, comprising:
a liquidproof plastic sock defining an inner space for receiving the human foot, and formed by plastic-welding a liquidproof plastic sheet which includes left and right segments, and a middle segment that is flanked by said left and right segments in a first direction, said middle segment having first and second marginal regions disposed oppositely in a second direction that is transverse to the first direction, and heel and metatarsal regions disposed between said first and second marginal regions, said first marginal region having a first gusset-shape cutout zone extending in the second direction toward said second marginal region to define first and second toe-side edges that converge to terminate at a first apical area, and that are plastic-welded to each other, said second marginal region having a second gusset-shape cutout zone extending in the second direction toward said first marginal region to define first and second heel-side edges that converge to terminate at a second apical area, and that are plastic-welded to each other, said left segment having a first left marginal edge, a second left marginal edge, and a first opening-defining marginal edge, said right segment having a first right marginal edge plastic-welded to said first left marginal edge, a second right marginal edge plastic-welded to said second left marginal edge, and a second opening-defining marginal edge disposed opposite to said first opening-defining marginal edge in the first direction, such that said inner space is defined by said left, middle and right segments, and such that said first and second opening-defining marginal edges that are left unwelded cooperatively define an opening to permit insertion of the human foot into said inner space therethrough;
a patch member disposed in said inner space to be bonded to said left, middle and right segments, and soaked with an exfoliating agent; and
a reinforcing pad soaked with the exfoliating agent, and disposed on said patch member to be registered with one of said heel and metatarsal regions of said middle segment such that the human foot inserted into said inner space comes into contact with said patch member and has a heel or metatarsal part thereof in intimate contact with said reinforcing pad.

2. The dead skin removing device of claim 1, wherein said middle segment has a pair of said first gusset-shape cutout zones and a pair of said second gusset-shape cutout zones.

3. The dead skin removing device of claim 1, wherein said reinforcing pad is formed in one-piece with said patch member, and is in a pleated form.

4. The dead skin removing device of claim 1, wherein said reinforcing pad is detachably disposed on said patch member.

5. A method of forming a dead skin removing device for a human foot, comprising the steps of:
(a) providing a liquidproof plastic sheet that includes left and right segments, and a middle segment which is flanked by the left and right segments in a first direction, and which includes first and second marginal regions disposed oppositely in a second direction that is transverse to the first direction, and heel and metatarsal regions disposed between the first and second marginal regions, the first marginal region having a first gusset-shape cutout zone extending in the second direction toward the second marginal region to define first and second toe-side edges that converge to terminate at a first apical area, the second marginal region having a second gusset-shape cutout zone extending in the second direction toward the first marginal region to define first and second heel-side edges that converge to terminate at a second apical area, the left segment having a first left marginal edge, a second left marginal edge, and a first opening-defining marginal edge, the right segment having a first right marginal edge that is spaced apart from the first left marginal edge by the first marginal region, a second right marginal edge that is spaced apart from the second left marginal edge by the second marginal region, and a second opening-defining marginal edge that is disposed opposite to the first opening-defining marginal edge in the first direction;
(b) providing a patch member which has substantially a same configuration as that of the liquidproof plastic sheet and which is superimposed thereupon for bonding therewith;
(c) causing a reinforcing pad to be provided on the patch member to be registered with one of the heel and metatarsal regions of the middle segment;
(d) causing the patch member and the reinforcing pad to be soaked with an exfoliating agent; and
(e) plastic-welding the first left marginal edge to the first right marginal edge, the first toe-side edge to the second toe-side edge, the second left marginal edge to the second right marginal edge, and the first heel-side edge to the second heel-side, such that the liquid plastic sheet is formed into a liquidproof plastic sock having an opening defined by the first and second opening-defining marginal edges that are left unwelded, and an inner space defined by the left, middle and right segments, with the patch member and the reinforcing pad disposed inside the inner space, thereby permitting insertion of the human foot into the inner space through the opening to come into contact with the patch member, with a heel or metatarsal part of the human foot in intimate contact with the reinforcing pad.

6. The method of claim 5, wherein the first marginal region has a pair of the first gusset-shape cutout zones, and the second marginal region has a pair of the second gusset-shape cutout zones.

7. The method of claim 5, wherein the reinforcing pad is formed in one-piece with the patch member, and is in a pleated form.

8. The method of claim 5, wherein the patch member is adhesively bonded to the liquidproof plastic sheet.

9. The method of claim 5, wherein the reinforcing pad is detachably disposed on the patch member.
